(19) United States
(12) Patent Application Publication
(10) Pub. No.: US 2025/0138486 A1
(43) Pub. Date: May 1, 2025

(54) BALANCE FOR A HOROLOGICAL MOVEMENT

(71) Applicant: Nivarox-FAR S.A., Le Locle (CH)

(72) Inventors: Christian CHARBON, Chézard-St-Martin (CH); Jean-Pierre MIGNOT, Pontarlier (FR); Marco VERARDO, Les Bois (CH)

(73) Assignee: Nivarox-FAR S.A., Le Locle (CH)

(21) Appl. No.: 18/701,650

(22) PCT Filed: Dec. 5, 2022
(86) PCT No.: PCT/EP2022/084457

§ 371 Date: Apr. 16, 2024

(30) Foreign Application Priority Data
Dec. 15, 2021 (EP) 21214801.9

(51) Int. Cl. G04B 43/00; G04B 13/02; G04B 17/06

(52) U.S. Cl. CPC G04B 43/00; G04B 13/02; G04B 17/06

(57) ABSTRACT

The present invention relates to a balance (1) including a hub (2) connected to a fellos (3) by at least one arm (4), characterised in that the felloe is made of a material whose relative magnetic permeability is less than 1.01, whose density is greater than 6.5, and which is electrically insulating.

### TECHNICAL FIELD OF THE INVENTION

The invention relates to a balance for a timepiece, as well as a staff/balance assembly.

### TECHNOLOGICAL BACKGROUND

The regulating member of a timepiece typically includes a flywheel referred to as the balance. This part is decisive for the quality of the running of the timepiece. More specifically, the combination of a balance and a balance spring forms an oscillator that regulates the movement at a specific frequency.

Currently, in a balance for a watch movement, the felloe and arms are made from a copper-based alloy, in particular copper-beryllium, from brass, from nickel silver or from Declafor. Copper-beryllium, which is primarily used, offers an advantageous combination of qualities including, in particular, non-magnetism, good chemical stability and sufficient mechanical features. The density of these alloys is typically greater than 8.

The problem posed by magnetic fields is well known to watchmakers and is encountered more and more often. Magnetic fields are becoming more and more prevalent in everyday life and disrupt the operation of mechanical watches, causing them to drift considerably.

To solve this problem, the solutions envisaged so far all revolve around non-magnetic materials for the balance-spring (Si or Nb-based alloys), the pivoting points (balance staff, pallet-lever stem, escapement pinion), the wheel plates and pallet-lever plates.

The materials used for the balance felloe are usually non-magnetic: brass, nickel silver or copper-beryllium, but they also have good electrical conductivity.

Despite the combination of all of these non-magnetic materials, a movement will still drift significantly in a magnetic field.

It is typically accepted that this drift is due to the presence of ferromagnetic elements in the components of the movement other than the escapement and oscillator, such as the balance spring stud or winding stem, for example.

Thus, even if these parts are replaced by parts made of materials without ferromagnetic elements, this drift in rate is still observed.

The inventors have discovered that this drift can be attributed to the influence of eddy currents. These occur when a conductive material is moving in a magnetic field gradient or when a balance is rotating in a constant field parallel to the felloe of the balance, which also affects the rate of the balance.

Some watchmakers have also produced balances in which at least the felloe is made from ceramic or diamond materials. However, although these materials are non-magnetic, they are very difficult to machine into balances, and the manufacturing costs are very high.

One aim of the present invention is thus to offer a balance without the known limitations by using a specific alloy that is non-magnetic and insensitive to eddy currents, while having a density greater than 6.5 to allow the balance to be integrated into the space available for a given movement. If the density is too low, as is typically the case with ceramics, the balance becomes too large for a given inertia and can no longer be housed in the movement.

### SUMMARY OF THE INVENTION

The invention solves the aforementioned drawbacks by offering a balance made from a non-magnetic, electrically insulating material with a density greater than 6.5.

To this end, the present invention relates to a balance including a hub connected to a felloe by at least one arm, and in which at least the felloe is made of a material whose relative magnetic permeability is less than 1.01, whose density is greater than 6.5, and which is not electrically conductive.

In accordance with other advantageous alternative embodiments of the invention:
the material preferably has an electrical conductivity of less than or equal to 2.5 MS/m, and more preferably less than 1.5 MS/m;
the material is chosen from: metals or metal alloys, ceramics, ceramic-metal composites, non-magnetic hard metals;
the material is an alloy containing chromium, iron, nickel and/or cobalt as its main constituents;
the material has a face-centred cubic crystal structure;
the material is an austenitic alloy;
the austenitic alloy preferably has a chromium content greater than 10%, preferably greater than 15%;
the austenitic alloy is chosen from: 316L steel, 904L steel, Phynox or MP35N.

The invention relates to an assembly comprising a balance according to the invention and a staff arranged to receive said balance, the staff also being made of a material whose relative magnetic permeability is less than 1.01, whose density is greater than 6.5, and which is electrically insulating.

The invention further relates to a horological movement comprising a balance in accordance with the invention.

The invention further relates to a watch comprising a movement equipped with a balance according to the invention.

### DETAILED DESCRIPTION OF THE INVENTION

The invention relates to a balance which includes a staff made of non-magnetic material. The staff supports a balance comprising a felloe and at least one arm made in one piece with the felloe. The arms extend from the hub at the centre of the balance, into which the staff is pressed against a shoulder. Conventionally, the staff also supports a collet for attaching a balance spring (not shown).

According to the invention, the felloe is made of a non-magnetic, electrically insulating material with a density greater than 6.5.

For the purposes of this invention, a non-magnetic material is understood to mean a material with a relative magnetic permeability of less than 1.01.

An electrically insulating material is understood to mean a material with low or very low electrical conductivity.

According to the invention, the material from which the felloe is made has an electrical conductivity of less than or equal to 2.5 MS/m, and preferably the electrical conductivity is less than or equal to 1.5 MS/m. Such electrical conductivity makes it possible to limit the influence of eddy currents and thus drifts in rate when the watch is in a magnetic field.

The balance is made from a material selected from metals, metal alloys, ceramics such as ytterbium oxide, Europium (III) oxide, dysprosium oxide, cerium (IV) oxide or neodymium oxide, ceramic-metal composites or non-magnetic hard metals such as tungsten carbide with a nickel binder.

In a preferred embodiment of the invention, the balance is made from an alloy containing iron, chromium, nickel and/or cobalt as its main constituents, and has a face-centred cubic crystal structure.

Even more preferably, the balance is made from an austenitic alloy selected from 316L steel, 904L steel, Phynox or MP35N. Obviously, other austenitic alloys with similar properties can be used without any particular difficulty for a person skilled in the art.

Such an austenitic alloy preferably has a chromium (Cr) content greater than 10%, preferably greater than 15%.

For example, the alloy used to make the balance is a 316L steel consisting of a maximum of 0.02% carbon (C), a maximum of 1% silicon (Si), a maximum of 2% manganese (Mn), a maximum of 0.04% phosphorus (P), a maximum of 0.03% sulphur (S), between 16% and 18% chromium (Cr), between 2 and 2.5% molybdenum (Mo), and between 10.5% and 13% nickel (Ni).

According to the needs of a person skilled in the art, the balance is coated with a layer, in particular a decorative layer, by electroplating, PVD or CVD.

The invention further relates to a staff and balance assembly in which the staff receiving the balance is made from a material of the same type as the material from which the balance is made, namely a material whose relative magnetic permeability is less than 1.01, whose density is greater than 6.5, and which is electrically insulating. For example, a 316L steel balance could be mounted on a 904L steel staff.

The staff can be coated with a layer, in particular chemical NiP or NiB, to improve its properties, in particular its hardness and resistance to wear and friction.

The invention further relates to a horological movement and a timepiece equipped with a balance in accordance with the invention.

1. An assembly comprising a balance including a hub (2) connected to a felloe (3) by at least one arm (4), at least the felloe being made of a material whose relative magnetic permeability is less than 1.01, whose density is greater than 6.5, and which is electrically insulating, and a staff arranged to receive said balance, the staff also being made of a material whose relative magnetic permeability is less than 1.01, whose density is greater than 6.5, and which is electrically insulating.

2. The assembly according to claim 1, characterised in that the material has an electrical conductivity of preferably less than or equal to 2.5 MS/m, and more preferably less than 1.5 MS/m.

3. The assembly according to claim 1, characterised in that the material is chosen from metals, metal alloys, ceramics, ceramic-metal composites or non-magnetic hard metals.

4. The assembly according to claim 1, characterised in that the material is made from an alloy which contains iron, chromium, nickel and/or cobalt as its main constituents.

5. The assembly according to claim 1, characterised in that the material has a face-centred cubic crystal structure.

6. The assembly according to claim 1, characterised in that the material is an austenitic alloy.

7. The assembly according to claim 6, characterised in that the austenitic alloy has a chromium content greater than 10%, and preferably greater than 15%.

8. The assembly according to claim 6, characterised in that the austenitic alloy is chosen from: 316L steel, 904L steel, Phynox or MP35N.

9. A movement comprising the assembly according to claim 1.
